(19) United States
(12) Patent Application Publication
(10) Pub. No.: US 2013/0149596 A1
(43) Pub. Date: Jun. 13, 2013

(54) ELECTROLYTE SOLVENT CONTAINING IONIC LIQUIDS

(71) Applicant: E.I DU PONT DE NEMOURS AND COMPANY, Wilmington, DE (US)

(72) Inventor: MARK BRANDON SHIFLETT, Wilmington, DE (US)

(73) Assignee: E.I DU PONT DE NEMOURS AND COMPANY, Wilmington, DE (US)

(21) Appl. No.: 13/707,723

(22) Filed: Dec. 7, 2012

Related U.S. Application Data
(60) Provisional application No. 61/569,682, filed on Dec. 12, 2011.

(51) Int. Cl. H01M 10/056; H01M 2/02

(52) U.S. Cl. CPC H01M 10/056; H01M 2/02
USPC 429/163; 252/500; 429/199

(57) ABSTRACT

Binary solvents that may be useful as electrolyte solvents for nonaqueous battery systems, such as lithium ion batteries are described. The electrolyte solvents consist of two components, an ionic liquid (preferably containing a fluorinated anion) and a fluoroether. Electrolyte compositions comprising the electrolyte solvents and electrochemical cells comprising the electrolyte compositions are also described.

This application claims priority under 35 U.S.C. §119(e) from, and claims the benefit of, U.S. Provisional Application No. 61/568,682, filed Dec. 9, 2011, which is by this reference incorporated in its entirety as a part hereof for all purposes.

### TECHNICAL FIELD

The subject matter hereof relates to compositions containing ionic liquids and fluoroethers. The compositions described herein are useful as electrolyte solvents, and the subject matter hereof thus relates also to electrochemical cells utilizing these compositions as electrolyte solvents.

### BACKGROUND

Carbonate compounds are currently used as electrolyte solvents for nonaqueous batteries containing cathodes made from alkali metals, alkaline earth metals, or compounds comprising these metals, for example lithium ion batteries. Current lithium ion battery electrolyte solvents typically contain one or more linear carbonates, such as ethyl methyl carbonate, dimethyl carbonate or diethylcarbonate, optionally together with a cyclic carbonate, such as ethylene carbonate. However, at battery voltages above 4.4 V, these electrolyte solvents are subject to decomposition, resulting in a loss of battery performance. Additionally, there are safety concerns with the use of these electrolyte solvents because of their low boiling point and high flammability.

To overcome the limitations of conventional nonaqueous electrolyte solvents, solvents are needed that have low viscosity, high conductivity and low flammability, and that allow the proper migration of metal ions such as lithium between the cathode and anode.

The use of ionic liquids, either alone or in combination with organic solvents, for electrolyte solvents has been described. For example, Amine et al (U.S. Patent Application Publication No. 2011/0 076 572) describes a nonaqueous electrolyte solvent that includes a mixture of siloxane or a silane or a mixture thereof, a sulfone, and a fluorinated ether or fluorinated ester or a mixture thereof, an ionic liquid or a carbonate. Kato et al (U.S. Patent Application Publication No. 2010/0 099 031) discloses a nonaqueous electrolyte comprising a lithium salt and an ambient-temperature-molten salt (i.e. an ionic liquid) and a monofluorophosphate and/or a difluorophosphate. Additionally, Choi et al (U.S. Patent Application Publication No. 2010/0 028 785) describes an electrolyte for a lithium ion secondary battery that includes a nonaqueous organic solvent, a lithium salt, an ionic liquid, and an additive.

Despite disclosures in the literature as described above, a need remains for improved electrolyte solvents, which are highly stable to oxidation, and have a low viscosity, high conductivity, and a high boiling point, for use in nonaqueous battery systems, such as lithium ion batteries.

### SUMMARY

One embodiment of the disclosures herein provides a composition, useful for example as an electrolyte solvent, that includes an ionic liquid and at least one fluoroether. In various embodiments, the ionic liquid can contain a fluorinated cation and/or anion.

An ionic liquid suitable for use in a composition such as described herein can include, for example, those that contain a cation as described below, viz:

a cation selected from the group consisting of cations represented by the structures of the following formulae:

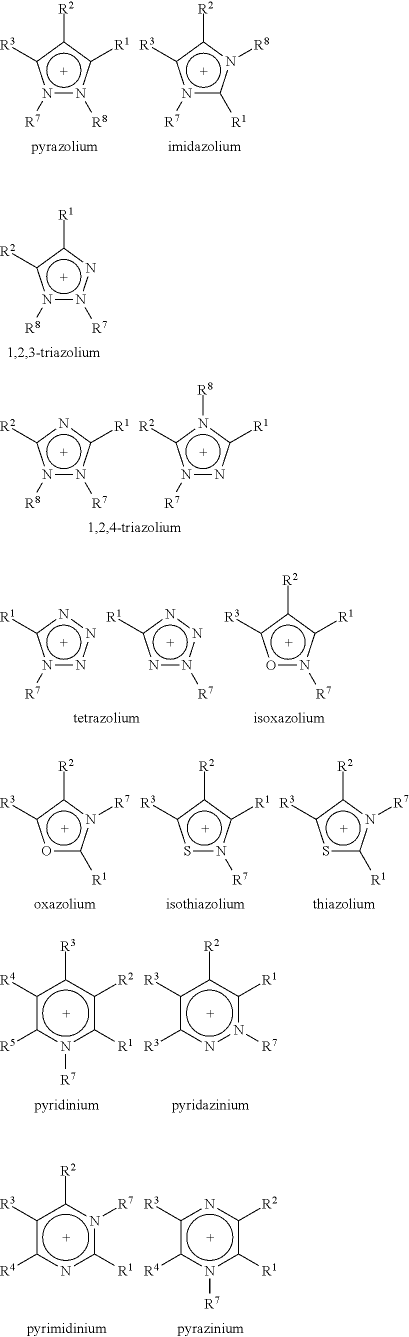

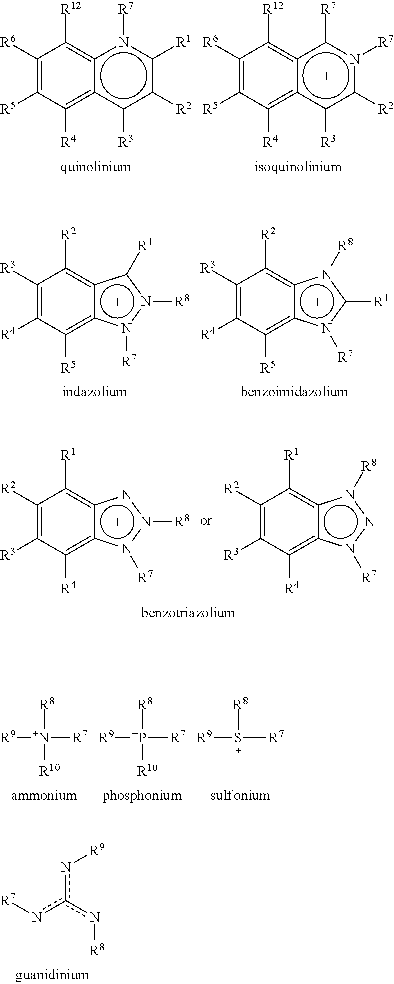

wherein:
R1, R2, R3, R4, R5, R6, and R12 are independently selected from the group consisting of:

(i) H,

(ii) halogen,

(iii) —CH3, —C2H5, or a C1 to C25 straight-chain, branched or cyclic alkane or alkene, group optionally substituted with at least one member selected from the group consisting of Cl, Br, F, I, OH, NH2 and SH;

(iv) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;

(v) a C6 to C20 unsubstituted aryl, or C1 to C25 unsubstituted heteroaryl, group having one to three heteroatoms independently selected from the group consisting of O, N, Si and S;

(vi) a C6 to C25 substituted aryl, or C1 to C25 substituted heteroaryl, group having one to three heteroatoms independently selected from the group consisting of O, N, Si and S; and wherein said substituted aryl or substituted heteroaryl group has one to three substituents independently selected from the group consisting of:
(A) —CH3, —C2H5, or a C1 to C25 straight-chain, branched or cyclic alkane or alkene group, optionally substituted with at least one member selected from the group consisting of Cl, Br, F, I, OH, NH2 and SH,
(B) OH,
(C) NH2, and
(D) SH; and

(vii) —(CH2)nSi(CH2)mCH3, —(CH2)nSi(CH3)3, or —(CH2)nOSi(CH3)m, where n is independently 1-4 and m is independently 0-4;

R7, R8, R9, and R10 are independently selected from the group consisting of:

(ix) —CH3, —C2H5, or a C1 to C25 straight-chain, branched or cyclic alkane or alkene group, optionally substituted with at least one member selected from the group consisting of Cl, Br, F, I, OH, NH2 and SH;

(x) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;

(xi) a C6 to C25 unsubstituted aryl, or C1 to C25 unsubstituted heteroaryl group, having one to three heteroatoms independently selected from the group consisting of O, N, Si and S; and

(xii) a C6 to C25 substituted aryl, or C3 to C25 substituted heteroaryl group, having one to three heteroatoms independently selected from the group consisting of O, N, Si and S; and wherein said substituted aryl or substituted heteroaryl has one to three substituents independently selected from the group consisting of:
(E) —CH3, —C2H5, or a C1 to C25 straight-chain, branched or cyclic alkane or alkene group, optionally substituted with at least one member selected from the group consisting of Cl, Br, F, I, OH, NH2 and SH,
(F) OH,
(G) NH2, and
(H) SH; and

(xiii) —(CH2)nSi(CH2)mCH3, —(CH2)nSi(CH3)3, or —(CH2)nOSi(CH3)m, where n is independently 1-4 and m is independently 0-4;
wherein optionally at least two of R1, R2, R3, R4, R5, R6, R7, R⁸, R⁹ and R¹⁰ can together form a cyclic or bicyclic alkanyl or alkenyl group.

An ionic liquid can, for example, be present in a composition hereof at a concentration greater than about 1×10⁻⁶ M but less than about 1×10⁻³ M.

A fluoroether suitable for use in a composition hereof can be represented by the structure of the formula R¹⁶—O—R¹⁷; wherein R¹⁶ and R¹⁷ are each independently a C₁ to C₇ linear or branched alkyl group, and wherein at least one of R¹⁶ or R¹⁷ contains at least one fluorine atom.

In another embodiment, the subject matter hereof provides a composition that includes (a) the solvent composition described above; and (b) an electrolyte salt.

In yet another embodiment, the subject matter hereof provides an electrochemical cell that includes:

a) a housing;

b) an anode and a cathode disposed in said housing and in ionically conductive contact with one another; and

c) the solvent composition described above disposed in said housing and providing an ionically conductive pathway between the anode and the cathode.

An electronic article that contains an electrochemical cell as described above is also provided as another embodiment of the subject matter hereof.

### BRIEF DESCRIPTION OF THE DRAWINGS

FIG. 1 is a graph of the measured conductivity of aqueous solutions of [emim][Tf2N] versus the square root of the concentration of [emim][Tf2N], as described in Example 2 herein.

### DETAILED DESCRIPTION

As used above and throughout the description of the subject matter hereof, the following terms, unless otherwise indicated, shall be defined as follows:

The term “ionic liquid” refers to an organic salt that is fluid at or below about 100° C.

The term “fluorinated anion” as used herein, refers to a negatively charged ion that contains at least one fluorine atom.

The term “fluorinated cation” as used herein, refers to a positively charged ion that contains at least one fluorine atom.

The term “electrolyte composition” as used herein, refers to a chemical composition suitable for use as an electrolyte in an electrochemical cell. An electrolyte composition typically comprises at least one solvent and at least one electrolyte salt.

The term “electrolyte salt” as used herein, refers to an ionic salt that is at least partially soluble in the solvent of the electrolyte composition, and that at least partially dissociates into ions in the solvent of the electrolyte composition to form a conductive electrolyte composition.

The term “anode” refers to the electrode of an electrochemical cell at which oxidation occurs. In a galvanic cell, such as a battery, the anode is the negatively charged electrode.

The term “cathode” refers to the electrode of an electrochemical cell at which reduction occurs. In a galvanic cell, such as a battery, the cathode is the positively charged electrode.

The term “lithium ion battery” refers to a type of rechargeable battery in which lithium ions move from the anode to the cathode during discharge, and from the cathode to the anode during charge.

Disclosed herein are binary solvents that are useful for a variety of purpose, including without limitation the purpose of use as electrolyte solvents for nonaqueous battery systems, such as lithium ion batteries.

### Ionic Liquids

Ionic liquids suitable for use as a component in a composition hereof (as disclosed herein) can, in principle, be any ionic liquid. In a preferred embodiment, an ionic liquid as used herein contains a fluorinated anion. Additionally, mixtures of two or more ionic liquids may be used.

Many ionic liquids are formed by reacting a nitrogen-containing heterocyclic ring, preferably a heteroaromatic ring, with an alkylating agent (for example, an alkyl halide) to form a cation. Examples of suitable heteroaromatic rings include substituted pyridines and imidazoles. These rings can be alkylated with virtually any straight, branched or cyclic C1-20 alkyl group, but preferably, the alkyl groups are C1-16 groups. Various other cations such as ammonium, phosphonium, sulfonium, and guanidinium may also be used for this purpose. Ionic liquids suitable for use herein may also be synthesized by salt metathesis, by an acid-base neutralization reaction or by quaternizing a selected nitrogen-containing compound; or they may be obtained commercially from several companies such as Merck (Darmstadt, Germany), BASF (Mount Olive, N.J.), Fluka Chemical Corp. (Milwaukee, Wis.), and Sigma-Aldrich (St. Louis, Mo.). For example, the synthesis of many ionic liquids is described by Shiflet et al (U.S. Patent Application Publication No. 2006/0 197 053.

Representative examples of ionic liquids suitable for use herein are included among those that are described in sources such as J. Chem. Tech. Biotechnol., 68:351-356 (1997); Chem. Ind., 68:249-263 (1996); J. Phys. Condensed Matter, 5: (supp 34B):B99-B106 (1993); Chemical and Engineering News, Mar. 30, 1998, 32-37; J. Mater. Chem., 8:2627-2636 (1998); Chem. Rev., 99:2071-2084 (1999); and WO 05/113,702 (and references cited therein). In one embodiment, a library, i.e., a combinatorial library, of ionic liquids may be prepared, for example, by preparing various alkyl derivatives of a quaternary ammonium cation, and varying the associated anions.

Ionic liquids suitable for use herein contain, for example, a cation and an anion. In various embodiments, the cation can be a fluorinated cation and/or the anion can be a fluorinatd anion.

In various other embodiments, the cation can be selected from the group consisting of cations represented by the structures of the following formulae:

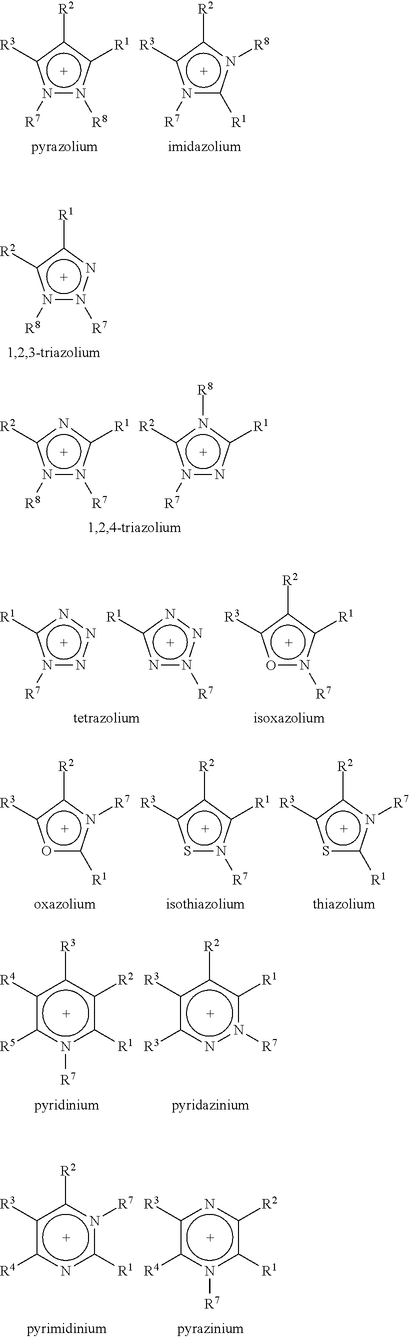

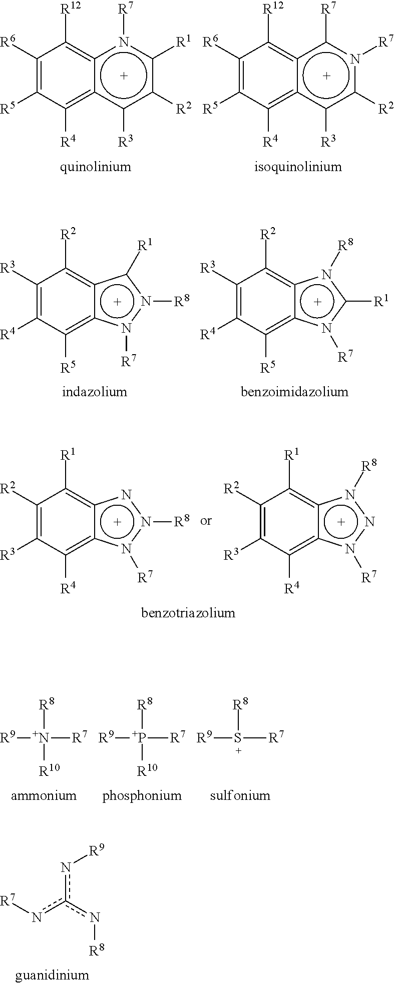

wherein:
R1, R2, R3, R4, R5, R6, and R12 are independently selected from the group consisting of:

(i) H,

(ii) halogen,

(iii) —CH3, —C2H5, or a C1 to C25 straight-chain, branched or cyclic alkane or alkene, group optionally substituted with at least one member selected from the group consisting of Cl, Br, F, I, OH, NH2 and SH;

(iv) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;

(v) a C6 to C20 unsubstituted aryl, or C1 to C25 unsubstituted heteroaryl, group having one to three heteroatoms independently selected from the group consisting of O, N, Si and S;

(vi) a C6 to C25 substituted aryl, or C1 to C25 substituted heteroaryl, group having one to three heteroatoms independently selected from the group consisting of O, N, Si and S; and wherein said substituted aryl or substituted heteroaryl group has one to three substituents independently selected from the group consisting of:
(A) —CH3, —C2H5, or a C1 to C25 straight-chain, branched or cyclic alkane or alkene group, optionally substituted with at least one member selected from the group consisting of Cl, Br, F, I, OH, NH2 and SH,
(B) OH,
(C) NH2, and
(D) SH; and

(vii) —(CH2)nSi(CH2)mCH3, —(CH2)nSi(CH3)3, or —(CH2)nOSi(CH3)m, where n is independently 1-4 and m is independently 0-4;

R7, R8, R9, and R10 are independently selected from the group consisting of:

(ix) —CH3, —C2H5, or a C1 to C25 straight-chain, branched or cyclic alkane or alkene group, optionally substituted with at least one member selected from the group consisting of Cl, Br, F, I, OH, NH2 and SH;

(x) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;

(xi) a C6 to C25 unsubstituted aryl, or C1 to C25 unsubstituted heteroaryl group, having one to three heteroatoms independently selected from the group consisting of O, N, Si and S; and

(xii) a C6 to C25 substituted aryl, or C3 to C25 substituted heteroaryl group, having one to three heteroatoms independently selected from the group consisting of O, N, Si and S; and wherein said substituted aryl or substituted heteroaryl has one to three substituents independently selected from the group consisting of:
(E) —CH3, —C2H5, or a C1 to C25 straight-chain, branched or cyclic alkane or alkene group, optionally substituted with at least one member selected from the group consisting of Cl, Br, F, I, OH, NH2 and SH,
(F) OH,
(G) NH2, and
(H) SH; and

(xiii) —(CH2)nSi(CH2)mCH3, —(CH2)nSi(CH3)3, or —(CH2)nOSi(CH3)m, where n is independently 1-4 and m is independently 0-4;
wherein optionally at least two of R1, R2, R3, R4, R5, R6, R7, R8, R9 and R10 can together form a cyclic or bicyclic alkanyl or alkenyl group.

Ionic liquids suitable for use as disclosed herein can, as noted above, contain a fluorinated anion. In one embodiment, a fluorinated anion can be selected from one or more members of the group consisting of tetrafluoroborate, tetrafluoroethanesulfonate, [BF4]-, [PF6]-, [SbF6], [CF3SO3]-, [HCF2CF2SO3], [CF3HFCCF2SO3]-, [HCClFCF2SO3]-, [(CF3SO2)2N]—, [(CF3CF2SO2)2N]—, [(CF3SO2)3C]-, [CF3CO2]-, [CF3OCFHCF2SO3]-, [CF3CF2OCFHCF2SO3]-, [CF3CFHOCF2CF2SO3]-, [CF2HCF2OCF2CF2SO3]-, [CF2ICF2OCF2CF2SO3], [CF3CF2OCF2CF2SO3]-, [(CF2HCF2SO2)2N]—, [(CF3CFHCF2SO2)2N]—, and F—.

In another embodiment, an ionic liquid can contain a fluorinated anion selected from one or more members of the group consisting of 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

In other embodiments, an ionic liquid suitable for use herein can contain a cation selected from one or more members of the group consisting of pyridinium, pyridazinium, pyrimidinium, pyrazinium, imidazolium, pyrazolium, triazolium, oxazolium, triazolium, phosphonium, ammonium, and guanidinium cations.

In another embodiment, 1-ethyl-3-methylimidazolium tetrafluoroborate, also referred to herein as [emim][Tf2N], can be used as an ionic liquid herein.

### Fluoroethers

A composition as disclosed herein contains at least one fluoroether. A fluoroether suitable for use in a composition hereof can be represented by the structure of the formula R¹⁶—O—R¹⁷; wherein R¹⁶ and R¹⁷ are each independently a C₁ to C₇ linear or branched alkyl group, and wherein at least one of R¹⁶ or R¹⁷ contains at least one fluorine atom.

In various embodiments, a fluoroether as used herein can be selected from the group consisting of

### CF3CF2CF2-O—CH3,

### CF3CF2CF2CF2-O—CH3,

### CF3CF2CF2CF2-O—CH2CH3,

### CF3CF2CF(OCH3)CF(CF3)2,

### CF3CF2CF2CF(OCH2CH3)CF(CF3)2, and

mixtures thereof.

### Electrolyte Solvent

The compositions disclosed herein can be used as a solvent in a formulated electrolyte composition. A composition hereof, particularly when used as an electrolyte solvent, is a binary solvent mixture containing at least one ionic liquid, as described above, and at least one fluoroether, as described above. The composition is prepared by mixing the two components. Particularly when a composition hereof is used as an electrolyte solvent, the concentration of the ionic liquid in the composition is typically greater than about 1×10⁻⁶ M but less than about 1×10⁻³ M, and more particularly, is typically greater than about 1×10⁻⁵ M but less than about 1×10⁻⁴ M.

The compositions hereof consist of two components, an ionic liquid containing a fluorinated anion and a fluoroether, which means that each such composition excludes, and is formed in the absence of, any other component except impurities such as contaminants or manufacturing residues. For example, when a composition hereof is used as an electrolyte solvent, it is a mixture that excludes, and from which there is absent, any other type of organic solvent, such as an ester, carbonate or non-fluorine-containing ether solvent.

Examples of ester solvents that are excluded from the composition of this invention include those represented by the structure of the following formula:

R²⁰—C(O)O—R²¹

wherein R²⁰ is an alkyl group which has 1 to 2 carbon atoms and may have a fluorine atom, and R²¹ is an alkyl group which has 1 to 4 carbon atoms and may have fluorine atom. Examples of chain carbonate solvents that are excluded from the composition of this invention include those represented by the structure of the following formula:

R²²—C(O)O—R²³

wherein R22 is a fluorine-containing alkyl group having 1 to 4 carbon atoms, and R23 is an alkyl group which has 1 to 4 carbon atoms and may have a fluorine atom. Examples of cyclic carbonate solvents that are excluded from the composition of this invention include those represented by the structure of the following formula:

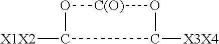

wherein X1, X2, X3 and X4 are the same or different and each is hydrogen atom, or an alkyl group which has 1 to 4 carbon atoms and that may have fluorine atom. Non-fluorine-containing ether solvents that are excluded from the compositions of this invention include those represented by the above structure in which neither R¹⁶ or R¹⁷ has fluorine substitution. Ester, chain and cyclic carbonate, and non-fluorine-containing ether solvents as described above are further discussed in US 2011/0 111 307.

The compositions hereof exclude these other kinds of solvents in relation to the observation that, to provide a useful electrolyte solvent, components other than an ionic liquid and a fluoroether are generally not needed for useful results; and that, in various instances, the presence of other kinds of solvents can actually make the behavior of the solvent mixture more unpredictable and more difficult to adapt to a system containing particular electrode materials.

### Electrolyte Composition

Also disclosed herein is a composition suitable for use in an electrochemical cell as an electrolylte, and it contains for that purpose the electrolyte solvent described above and an electrolyte salt. In a preferred embodiment, the electrolyte composition may contain various additives known in the art, such as a surfactant or stabilizer, but does not, as discussed above, contain any other type of organic solvent.

Suitable electrolyte salts for use in an electrochemical cell, such as a lithium ion battery, include without limitation

lithium hexafluorophosphate,
lithium bis(trifluoromethanesulfonyl)imide,
lithium bis(perfluoroethanesulfonyl)imide,
lithium tetrafluoroborate,
lithium perchlorate,
lithium hexafluoroarsenate,
lithium trifluoromethanesulfonate,
lithium tris (trifluoromethanesulfonyl)methide,
lithium bis(oxalato)borate,
Li2B12F12-xHx where x is equal to 0 to 8, and mixtures of lithium fluoride and anion receptors such as B(OC6F5)3.

In one embodiment, the electrolyte salt is lithium hexafluorophosphate.

### Electrochemical Cell

In another embodiment, the subject matter hereof provides an electrochemical cell comprising a housing; an anode and a cathode disposed in the housing and in ionically conductive contact with one another; an electrolyte composition, as described above, providing an ionically conductive pathway between the anode and the cathode; and a porous separator between the anode and the cathode. The housing may be any suitable container to house the electrochemical cell components. The anode and the cathode may be comprised of any suitable conducting material depending on the type of electrochemical cell.

Suitable examples of anode materials include without limitation lithium metal, lithium metal alloys, aluminum, platinum, palladium, graphite, transition metal oxides, and lithiated tin oxide. Suitable examples of cathode materials include without limitation graphite, aluminum, platinum, palladium, electroactive transition metal oxides comprising lithium, indium tin oxide, and conducting polymers such as polypyrrole and polyvinylferrocene.

The porous separator serves to prevent short circuiting between the anode and the cathode. The porous separator typically consists of a single-ply or multi-ply sheet of a microporous polymer such as polyethylene, polypropylene, or a combination thereof. The pore size of the porous separator is sufficiently large to permit transport of ions, but small enough to prevent contact of the anode and cathode either directly or from particle penetration or dendrites which can from on the anode and cathode.

In one embodiment, the electrochemical cell is a lithium ion battery. Suitable anode materials for a lithium ion battery include without limitation lithium metal, lithiated carbon, or a lithium alloy. Suitable cathode materials for a lithium ion battery include without limitation electroactive transition metal oxides comprising lithium, such as LiCoO2, LiNiO2, LiMn2O4, or LiV3O8. Electrolyte compositions suitable for use in lithium ion batteries are described above.

The electrochemical cells disclosed herein may be used as a power source in various electronic articles such as computers, power tools, automobiles, and telecommunication devices.

### EXAMPLES

This invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

The meaning of abbreviations used is as follows: “min” means minute(s), “h” means hour(s), “mL” means milliliter(s), “μL” means microliter(s), “g” means gram(s), “mg” means milligram(s), “μg” means microgram(s), “cm” means centimeter(s), “mm” means millimeter(s), “mol” means mole(s), “mol %” means mole percent relative to the total number of moles in the system, “dm3” means cubic decimeter(s), “HPLC” means high performance liquid chromatography, “S” means siemen(s).

### Materials:

The following hydrofluoroethers were obtained from 3M Corporation (St. Paul, Minn.):
HFE-7000 (Novec™ 7000 Engineered Fluid, I.D. No. 98-0212-2969-9, Lot No. 920013, 1-methoxyheptafluoropropane, CF3CF2CF2-O—CH3, CAS registry no. 375-03-1);
HFE-7100 (Novec™ 7100 Engineered Fluid, I.D. No. 98-0211-8940-6, Lot No. 924322, consists of two inseparable isomers with essentially identical properties: 1-methoxynonafluoroisobutane (CF3)2CFCF2-O—CH3, CAS registry no. 163702-08-7, and 1-methoxynonafluorobutane CF3CF2CF2CF2-O—CH3, CAS registry no. 163702-07-6);
HFE-7200 (Novec™ 7200 Engineered Fluid, I.D. No. 98-0211-9362-2, Lot No. 924175, consists of two inseparable isomers with essentially identical properties: 1-ethoxynonafluoroisobutane (CF3)2CFCF2-OCH2CH3, CAS registry no. 163702-06-5, and 1-ethoxynonafluorobutane CF3CF2CF2CF2-O—CH2CH3, CAS registry no. 163702-05-4);
HFE-7300 (Novec™ 7300 Engineered Fluid, 1,1,1,2,2,3,4,5,5,5-decafluoro-3-methoxy-4-(trifluoromethyl)-pentane, CF3CF2CF(OCH3)CF—(CF3)2, CAS registry no. 132182-92-4); and
HFE-7500 (Novec 7500 Engineered Fluid, I.D. No. 98-0212-2932-7, Lot No. 920038,2-trifluoromethyl-3-ethoxydodecafluorohexane, CF3CF2CF2CF(OCH2CH3)CF(CF3)2, CAS registry no. 297730-93-9).

The purities of these hydrofluoroethers were each 99.0% and were determined using a gas chromatography-mass spectrometry (GCMS) method (Agilent 6890N, Restek Rtx-200 column, 105 m×0.25 mm).

The ionic liquid [emim][Tf2N] (EMIIm, electrochemical grade, assay≧99.5%, C8H11F6N3O4S2, Lot and Catalog no. 259095 IL-201-20-E, CAS registry no.174899-82-2) was purchased from Covalent Associates Inc. (Woburn, Mass.) unless noted otherwise. The [emim][Tf2N] sample was analyzed to verify the stated purity. The initial as-received mass fraction of water therein was measured by Karl Fischer titration (Aqua-Star C3000, solutions AquaStar Coulomat C and A). The sample contained a water mass fraction of about 413×10⁻⁶.

A 20 mL sample of water was used to extract fluorine, chlorine, and bromine from 0.2 g of [emim][Tf2N] at ambient temperature for 24 h. The extractable ions were measured by ion chromatography (column, DIONEX AS17; eluant, (0.4 to 50) mM NaOH; flow, 1.0 mL·min-1; sample loop, 100 μL). The fluorine, chlorine, and bromine ions were found to be below the detection limit (<5 pg·μmL-1).

A 0.1886 g sample of [emim][Tf2N] was combusted in a Wickbold torch, and the combustion gases were collected in water (99.86 mL) and analyzed by ion chromatography for total chlorine content. Two separate samples were analyzed and found to contain a chlorine mass fraction of (440 and 480)×10-6, with an average of (460±20)×10-6.

Elemental analysis was performed by Schwarzkopf Microanalytical Laboratory, Inc. (Woodside, N.Y.) for carbon (24.60%), hydrogen (3.02%), fluorine (29.70%), nitrogen (10.75%), and sulfur (17.05%) content. Combining the results from each of the techniques described, it was concluded that the [emim][Tf2N] sample purity was 99.4%, which compares closely with the stated purity 99.5%) by the manufacturer.

The [emim][Tf2N] was dried and degassed by first filling a borosilicate glass tube with about 10 g of the ionic liquid and pulling a coarse vacuum with a diaphragm pump (Pfeiffer, model MVP055-3, Nashua, N.H.) for about 3 h. Next, the [emim]-[Tf2N] was completely evacuated using a turbopump (Pfeiffer, model TSH-071) to a pressure of about 4×10-7 kPa while simultaneously heating and stirring the ionic liquid at a temperature of about 348° K for 5 days. The final mass fraction of water was again measured by Karl Fischer titration, and the dried sample contained 188×10-6.

### Example 1

### Solubility of the Ionic Liquid [emim][Tf2N] in Hydrofluoroethers

The solubility of [emim][Tf2N] in the hydrofluoroethers HFE-7000, HFE-7100, HFE-7200, HFE-7300, and HFE-7500 was studied using the method described by Shiflett et al. (J. Chem. Eng. Data 2007:2413-2418, 2007; and J. Phys. Chem. B 110:14436-14443, 2006). A summary of the experimental method is given below.

Low-pressure sample containers were fabricated from borosilicate glass tubing with an outside diameter of 12.69 mm, an inside diameter of 7.94 mm, and an overall length of 15.5 cm. The glass tubing was sealed with a torch on one end and left open on the other. The borosilicate glass tubes were cleaned in an ultrasonic bath filled with acetone for 2 h and dried overnight in a vacuum oven at 348.15° K. The volume of each liquid layer was obtained by measuring the liquid height from the bottom of the glass tubing using an electronic caliper (Mitutoyo Corp., model no. CD-6″ CS, code no. 500-196) with an accuracy of ±0.01 mm. The volume, v, versus the height, h, was calibrated experimentally using methyl alcohol 99.9%, Sigma-Aldrich, Inc., St. Louis, Mo.), and a linear relation was obtained. The uncertainty in the volume gas was estimated to be ±0.25%.

The sample containers were initially weighed to determine the tare mass. The samples were then prepared in a nitrogen purged drybox to minimize water contact with the hygroscopic [emim][Tf2N] ionic liquid. A glass pipet was used to add the required amounts of [emim][Tf2N] ionic liquid and hydrofluoroethers. Two samples containing mole fractions of about (30 and 90) % for each hydrofluoroether and [emim][Tf2N] ionic liquid were prepared. The uncertainty in the mole fraction was estimated to be ±0.01% (i.e., 10-4). A Swagelok stainless steel (SS316) cap and plug with Teflon ferrules was used to seal the open end of the glass tubing before removing from the drybox. Care was required when tightening the cap so that the ferrules sealed against the glass tubing, but the cap was not over tightened such that it cracked the glass. The masses remained constant within the accuracy (±0.0001 g) of the balance (Mettler Toledo, model AG204) even after several weeks.

Initially, the samples were mixed at room temperature (293.2° K) by vigorously shaking the sample containers. To establish thermodynamic equilibrium, sufficient time and mixing were required. A custom-made mixing apparatus, which held 14 sample containers, was designed for rocking the tubes back and forth inside a water-filled Plexiglas tank, and the temperature was controlled with an external temperature bath (PolyScience, model 1190S, Niles, Ill.) which circulated water through a copper coil inside the tank. The water bath was stirred with an agitator (Arrow Engineering Co., Inc., model 1750, Hillside, N.J.), and the temperature was measured with a thermocouple (Fluke Corporation, model 5211 thermometer, Everett, Wash.). The Fluke thermocouple was calibrated using a standard platinum resistance thermometer [SPRT model 5699, Hart Scientific, American Fork, Utah (range 73 to 933° K)] and readout (Blackstack model 1560 with SPRT module 2560). The Blackstack instrument and SPRT are a certified secondary temperature standard with a NIST traceable accuracy to ±0.005° K. The water bath temperature uncertainties were ±0.2° K.

The water bath temperature was initially set at about 283° K. Before height measurements were taken, the sample holder was positioned upright below the water level of the tank for 6 to 12 h. The volume of each liquid layer was obtained by measuring the liquid height from the bottom of the glass tube using the electronic caliper. To establish the equilibrium state, the mixing and measurement procedure was repeated each day, and the heights were plotted as a function of time until no further change in the heights was detected. Using this procedure required 5 days to reach equilibrium at 283° K. These experiments were repeated at various temperatures up to about 333° K.

All the systems studied exhibited large immiscibilities. In the systems containing HFE-7000, HFE-7100, and HFE-7200, the upper liquid phase was HFE-rich and the lower liquid phase was [emim][Tf2N]-rich. However, for the larger hydrofluoroethers, HFE-7300 and HFE-7500, the liquid densities (1.656 g·cm⁻³ and 1.616 g·cm⁻³ at 298.15° K, respectively) are larger than that of [emim][Tf2N] (1.517 g·cm⁻³ at 298.15° K), and the opposite observation was found.

To use the mass-volume method, the vapor phase was assumed to contain only HFE (negligible vapor pressure for [emim][Tf2N] ionic liquid). The HFE vapor density was also needed and was calculated assuming ideal gas behavior and using the Antoine equation [ln(P/Pa))A−B/(T/K)], as described by Shiflett et al. (J. Chem. Eng. Data 2007:2413-2418, 2007). The final equilibrium results for the molar compositions are provided in Table 1. In the table, x1′ is the mole fraction of the ionic liquid [emim][Tf2N] in the lower phase, and x1 s the mole fraction of the ionic liquid [emim][Tf2N] in the upper phase.

As can be seen from the data in Table 1, the equilibrium solubility for [emim][Tf2N] in the hydrofluoroethers studied was between about 0.1 and 0.5 mol % (5.6×10-2 and 2.8×10-1 M).

TABLE 1
Solubility of [emim] [Tf2N] in Hydrofluoroethers

| | | 100 × 1′ | 100 × 1 |
|---|---|---|---|
| System | T (° K.) | (mol %) | (mol %) |
| HFE-7000 + | 283.0 ± 0.2 | 17.3 ± 1.3 | 99.7 ± 0.3 |
| [emim] [Tf2N] | 294.9 ± 0.2 | 18.0 ± 0.9 | 99.9 ± 0.1 |
| | 303.4 ± 0.2 | 18.3 ± 1.0 | 99.8 ± 0.2 |
| | 313.7 ± 0.2 | 19.0 ± 0.7 | 99.7 ± 0.3 |
| | 323.7 ± 0.2 | 19.1 ± 0.7 | 99.7 ± 0.3 |
| | 333.0 ± 0.2 | 19.3 ± 0.6 | 99.7 ± 0.3 |
| HFE-7100 + | 283.0 ± 0.2 | 10.4 ± 1.8 | 99.8 ± 0.2 |
| [emim] [Tf2N] | 297.1 ± 0.2 | 10.4 ± 1.8 | 99.6 ± 0.4 |
| | 303.4 ± 0.2 | 10.8 ± 1.8 | 99.6 ± 0.4 |
| | 313.7 ± 0.2 | 11.2 ± 1.2 | 99.5 ± 0.4 |
| | 323.7 ± 0.2 | 11.5 ± 0.9 | 99.5 ± 0.4 |
| | 333.1 ± 0.2 | 11.9 ± 0.9 | 99.6 ± 0.4 |
| HFE-7200 + | 288.1.0 ± 0.2 | 6.9 ± 1.0 | 99.5 ± 0.5 |
| [emim] [Tf2N] | 297.2 ± 0.2 | 7.3 ± 0.9 | 100.0 ± 0.3 |
| | 303.4 ± 0.2 | 7.4 ± 0.9 | 99.6 ± 0.4 |
| | 313.7 ± 0.2 | 7.5 ± 0.9 | 100.0 ± 0.3 |
| | 323.8 ± 0.2 | 8.05 ± 0.8 | 99.7 ± 0.3 |
| | 333.1 ± 0.2 | 8.19 ± 0.8 | 100.0 ± 0.3 |
| HFE-7300 + | 283.1 ± 0.2 | 99.9 ± 0.1 | 2.8 ± 0.7 |
| [emim] [Tf2N] | 296.6 ± 0.2 | 100.0 ± 0.2 | 2.9 ± 0.6 |
| | 303.5 ± 0.2 | 100.0 ± 0.2 | 2.9 ± 0.7 |
| | 313.1 ± 0.2 | 99.9 ± 0.1 | 3.8 ± 0.8 |
| | 322.8 ± 0.2 | 99.9 ± 0.1 | 4.8 ± 0.8 |
| | 333.3 ± 0.2 | 99.9 ± 0.1 | 3.6 ± 0.7 |
| HFE-7500 + | 283.3 ± 0.2 | 99.5 ± 0.5 | 1.3 ± 0.8 |
| [emim] [Tf2N] | 297.3 ± 0.2 | 99.5 ± 0.5 | 2.1 ± 1.0 |
| | 303.5 ± 0.2 | 99.8 ± 0.2 | 1.9 ± 0.8 |
| | 313.5 ± 0.2 | 99.7 ± 0.3 | 1.7 ± 1.1 |
| | 323.8 ± 0.2 | 99.9 ± 0.1 | 1.4 ± 0.8 |
| | 333.1 ± 0.2 | 99.5 ± 0.5 | 4.3 ± 0.7 |

### Example 2

### Conductivity of [emim][Tf2N] in Water

The conductivity of [emim][Tf2N] in water was studied as a model system. The same trends in conductivity would be expected for solutions of [emim][Tf2N] in fluoroethers.

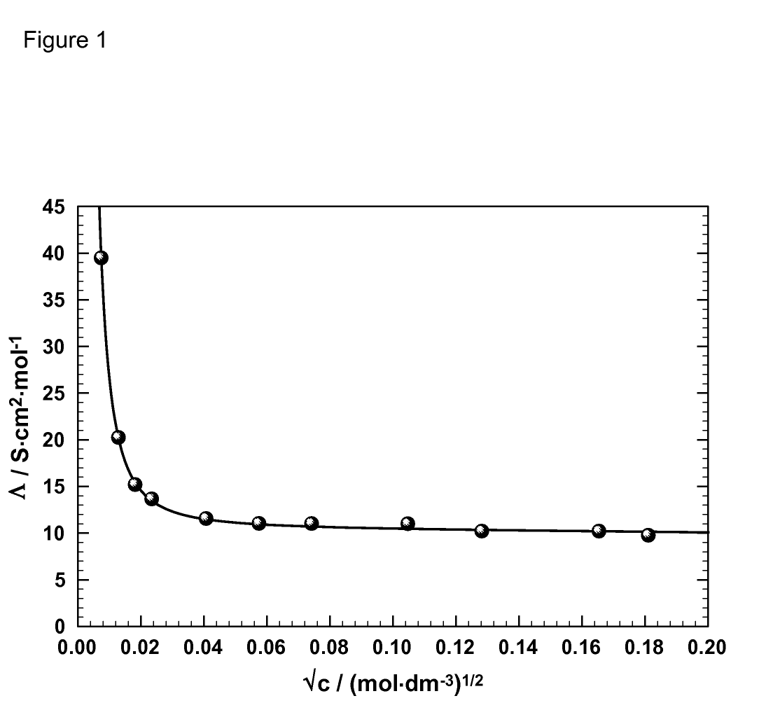

The [emim][Tf2N] used in this example was purchased from Fluka Chemical Corp. (Milwaukee, Wis.). The initial water content of this ionic liquid was 720 ppm. Aqueous solutions having concentrations ranging from 5.50×10-5 mol/dm3 to 3.28×10-2 mol/dm3 (5.50×10-5 M to 3.28×10-2 M) were prepared by mixing the [emim][Tf2N] with HPLC grade water (Sigma-Aldrich, Milwaukee, Wis.). The conductivity of the aqueous solutions of [emim][Tf2N] were measured at 25.1° C. (298.25° K) using a conductivity meter (Model 845, Amber Science, Inc., Eugene, Oreg.) with a platinum probe. The results are presented in FIG. 1 where the measured conductivity of the solutions (A, S·cm2·mol-1) is plotted versus the square root of the concentration (√c, (mol·dm−3)½).

As can be seen from FIG. 1, the conductivity of the aqueous solutions of [emim][Tf2N] begins to increase below about 4×10-2 (mol·dm-3)0.5 (1×10-3 M), and increases sharply below about 1×10-2 (mol·dm-3)0.5 (1×10-4 M).

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

Where a range of numerical values is recited or established herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, (a) lists of compounds, monomers, oligomers, polymers and/or other chemical materials include derivatives of the members of the list in addition to mixtures of two or more of any of the members and/or any of their respective derivatives; (b) amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value; and (c) all numerical quantities of parts, percentage or ratio are given as parts, percentage or ratio by weight; the stated parts, percentage or ratio by weight may but are not required to add up to 100.

What is claimed is:

1. A composition of matter consisting of at least one ionic liquid and at least at least one fluoroether.

2. A composition according to claim 1 wherein an ionic liquid comprises a cation selected from the group consisting of cations represented by the structures of the following formulae: 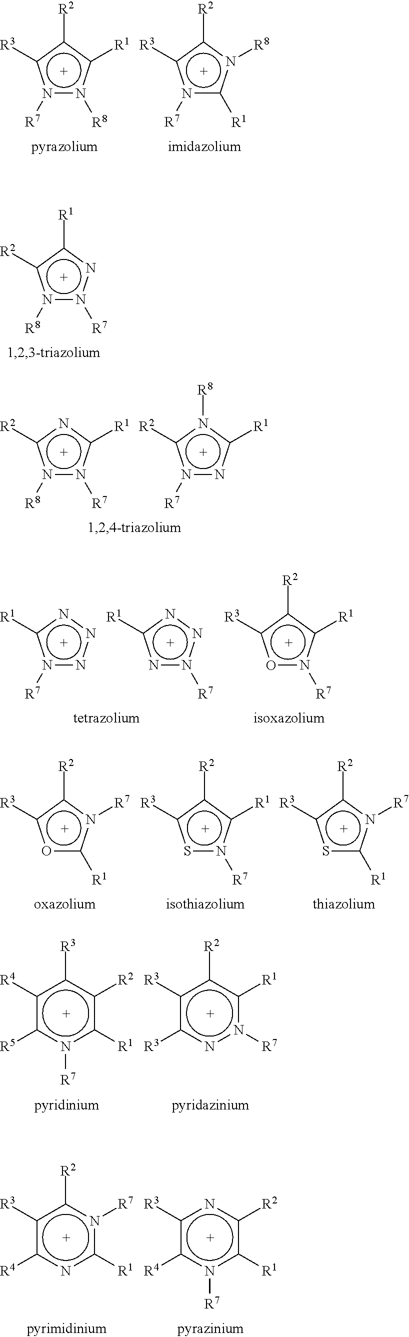 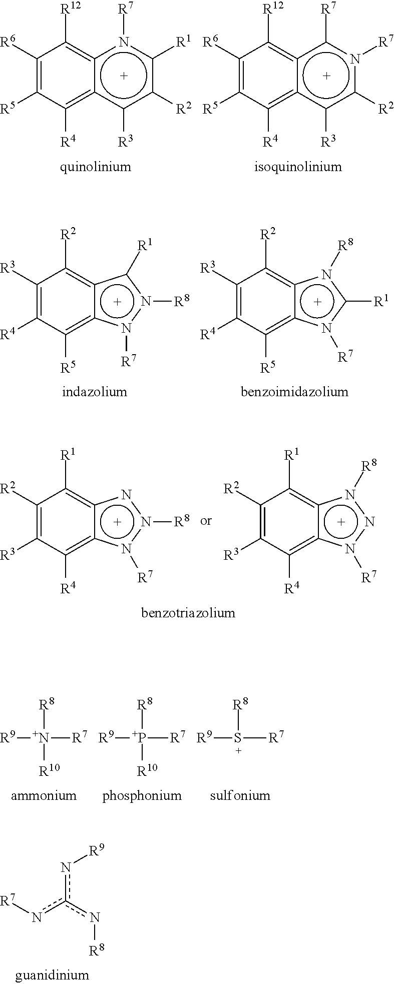
wherein:
R1, R2, R3, R4, R5, R6, and R12 are independently selected from the group consisting of:
(i) H,
(ii) halogen,
(iii) —CH3, —C2H5, or a C1 to C25 straight-chain, branched or cyclic alkane or alkene, group optionally substituted with at least one member selected from the group consisting of Cl, Br, F, I, OH, NH2 and SH;
(iv) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;
(v) a C6 to C20 unsubstituted aryl, or C1 to C25 unsubstituted heteroaryl, group having one to three heteroatoms independently selected from the group consisting of O, N, Si and S;
(vi) a C6 to C25 substituted aryl, or C1 to C25 substituted heteroaryl, group having one to three heteroatoms independently selected from the group consisting of O, N, Si and S; and wherein said substituted aryl or substituted heteroaryl group has one to three substituents independently selected from the group consisting of:
(A) —CH3, —C2H5, or a C1 to C25 straight-chain, branched or cyclic alkane or alkene group, optionally substituted with at least one member selected from the group consisting of Cl, Br, F, I, OH, NH2 and SH,
(B) OH,
(C) NH2, and
(D) SH; and
(vii) —(CH2)nSi(CH2)mCH3, —(CH2)nSi(CH3)3, or —(CH2)nOSi(CH3)m, where n is independently 1-4 and m is independently 0-4;
R7, R8, R9, and R10 are independently selected from the group consisting of:
(ix) —CH3, —C2H5, or a C1 to C25 straight-chain, branched or cyclic alkane or alkene group, optionally substituted with at least one member selected from the group consisting of Cl, Br, F, I, OH, NH2 and SH;
(x) —CH3, —C2H5, or a C1 to C25 straight-chain, branched or cyclic alkane or alkene group comprising one to three heteroatoms selected from the group consisting of O, N, Si and S, and optionally substituted with at least one member selected from the group consisting of Cl, Br, F, I, OH, NH2 and SH;
(xi) a C6 to C25 unsubstituted aryl, or C1 to C25 unsubstituted heteroaryl group, having one to three heteroatoms independently selected from the group consisting of O, N, Si and S; and
(xii) a C6 to C25 substituted aryl, or C3 to C25 substituted heteroaryl group, having one to three heteroatoms independently selected from the group consisting of O, N, Si and S; and wherein said substituted aryl or substituted heteroaryl has one to three substituents independently selected from the group consisting of:
(E) —CH3, —C2H5, or a C1 to C25 straight-chain, branched or cyclic alkane or alkene group, optionally substituted with at least one member selected from the group consisting of Cl, Br, F, I, OH, NH2 and SH,
(F) OH,
(G) NH2, and
(H) SH; and
(xiii) —(CH2)nSi(CH2)mCH3, —(CH2)nSi(CH3)3, or —(CH2)nOSi(CH3)m, where n is independently 1-4 and m is independently 0-4;
wherein optionally at least two of R1, R2, R3, R4, R5, R6, R7, R8, R9 and R10 can together form a cyclic or bicyclic alkanyl or alkenyl group.

3. A composition according to claim 1 wherein an ionic liquid comprises a fluorinated anion.

4. A composition according to claim 1 wherein a fluoroether is represented by the structure of the formula R¹⁶—O—R¹⁷; wherein R¹⁶ and R¹⁷ are each independently a C₁ to C₇ linear or branched alkyl group, and wherein at least one of R¹⁶ or R¹⁷ contains at least one fluorine atom.

5. A composition according to claim 1 wherein an ionic liquid is present in the composition at a concentration greater than about 1×10⁻⁶ M but less than about 1×10⁻³ M.

6. A composition according to claim 3 wherein a fluorinated anion is selected from one or more members of the group consisting of tetrafluoroborate, tetrafluoroethanesulfonate, [BF4]-, [PF6]-, [SbF6], [CF3SO3]-, [HCF2CF2SO3]-, [CF3HFCCF2SO3]-, [HCClFCF2SO3]-, [(CF3SO2)2N]—, [(CF3CF2SO2)2N]—, [(CF3SO2)3C]—, [CF3CO2]-, [CF3OCFHCF2SO3]-, [CF3CF2OCFHCF2SO3]-, [CF3CFHOCF2CF2SO3]-, [CF2HCF2OCF2CF2SO3]-, [CF21CF2OCF2CF2SO3], [CF3CF2OCF2CF2SO3]-, [(CF2HCF2SO2)2N]—, [(CF3CFHCF2SO2)2N]—, and F—.

7. A composition according to claim 3 wherein a fluorinated anion is selected from one or more members of the group consisting of 1,1,2,2-tetrafluoroethanesulfonate; 2-chloro-1,1,2-trifluoroethanesulfonate; 1,1,2,3,3,3-hexafluoropropanesulfonate; 1,1,2-trifluoro-2-(trifluoromethoxy)ethanesulfonate; 1,1,2-trifluoro-2-(pentafluoroethoxy)ethanesulfonate; 2-(1,2,2,2-tetrafluoroethoxy)-1,1,2,2-tetrafluoroethanesulfonate; 2-(1,1,2,2-tetrafluoroethoxy)-1,1,2,2-tetrafluoroethanesulfonate; 2-(1,1,2,2-tetrafluoro-2-iodoethoxy)-1,1,2,2-tetrafluoroethanesulfonate; 1,1,2,2-tetrafluoro-2-(pentafluoroethoxy)ethanesulfonate; N,N-bis(1,1,2,2-tetrafluoroethanesulfonyl)imide; and N,N-bis(1,1,2,3,3,3-hexafluoropropanesulfonyl)imide.

8. A composition according to claim 2 wherein a cation is selected from one or more members of the group of cations consisting of pyridinium, pyridazinium, pyrimidinium, pyrazinium, imidazolium, pyrazolium, triazolium, oxazolium, triazolium, phosphonium, ammonium, and guanidinium.

9. A composition according to claim 1 wherein an ionic liquid comprises 1-ethyl-3-methylimidazolium tetrafluoroborate.

10. A composition according to claim 1 wherein an ionic liquid is present in the composition at a concentration greater than about 1×10⁻⁵ M but less than about 1×10⁻⁴ M.

11. A composition according to claim 1 wherein a fluoroether is selected from the group consisting of:
CF3CF2CF2-O—CH3,
CF3CF2CF2CF2-O—CH3,
CF3CF2CF2CF2-O—CH2CH3,
CF3CF2CF(OCH3)CF(CF3)2,
CF3CF2CF2CF(OCH2CH3)CF(CF3)2, and mixtures thereof.

12. A composition of matter consisting essentially of (a) a composition according to claim 1, and (b) an electrolyte salt.

13. A composition according to claim 12 wherein an electrolyte salt is selected from the group consisting of lithium hexafluorophosphate,
lithium bis(trifluoromethanesulfonyl)imide,
lithium bis(perfluoroethanesulfonyl)imide,
lithium tetrafluoroborate,
lithium perchlorate,
lithium hexafluoroarsenate,
lithium trifluoromethanesulfonate,
lithium tris (trifluoromethanesulfonyl)methide,
lithium bis(oxalato)borate,
Li2B12F12-xHx where x is equal to 0 to 8, and
mixtures of lithium fluoride and B(OC6F5)3.

14. An electrochemical cell comprising:
a) a housing;
b) an anode and a cathode disposed in said housing and in ionically conductive contact with one another; and
c) a composition according to claim 12 disposed in said housing and providing an ionically conductive pathway between said anode and said cathode.

15. An electrochemical cell according to claim 14 which is a lithium ion battery.

16. An electronic article comprising an electrochemical cell according to claim 14.
